(19) United States
(12) Patent Application Publication
(10) Pub. No.: US 2018/0012316 A1
(43) Pub. Date: Jan. 11, 2018

(54) SYSTEMS AND METHODS FOR CONNECTING DISPARATE COMPUTING DEVICES VIA STANDARD INTERFACES AND DIRECT NETWORK CONNECTIONS

(71) Applicant: Alibaba Group Holding Limited, Grand Cayman (KY)

(72) Inventors: Yuzhou HUANG, Hangzhou (CN); Shaohua LI, Hangzhou (CN); Guanghua HU, Hangzhou (CN); Jing TAN, Hangzhou (CN); Xiaoxuan ZHANG, Hangzhou (CN); Yanjun LI, Hangzhou (CN); Yan GU, Hangzhou (CN)

(21) Appl. No.: 15/640,743

(22) Filed: Jul. 3, 2017

(30) Foreign Application Priority Data
Jul. 6, 2016 (CN) 201610530130.5

(51) Int. Cl. G06Q 50/12; G06Q 20/40; G06Q 20/24

(52) U.S. Cl. CPC G06Q 50/12; G06Q 20/24; G06Q 20/40

(57) ABSTRACT

Embodiments of the disclosure describe a data object information processing method, apparatus, and system. In one embodiment, the method comprises providing, by a platform server, hotel data object information to a client device, the hotel data object information including a plurality of type attributes including a credit type attribute; receiving, at the platform server, a reservation request from the client device, the reservation request including an identification of the credit type attribute; verifying, by the platform server and in response to the reservation request, a credit authorization of a user associated with the client device; generating, by the platform server, a credit-type booking upon verifying the credit authorization; transmitting, by the platform server, booking information associated with the credit-type booking to a hotel data processing system associated with a hotel; receiving, at the platform server, a check-out request from the hotel data processing system; and transferring, by the platform server, resources associated with the booking information from a payment account associated with the user to the hotel data processing system upon receiving the check-out request.

### CROSS-REFERENCE TO RELATED APPLICATIONS

This application claims the benefit of priority of Chinese Application No. 201610530130.5, titled “Method, Apparatus, and System of Processing Data Object Information,” filed on Jul. 6, 2016, which is hereby incorporated by reference in its entirety.

### BACKGROUND

### Technical Field

The disclosure relates to the field of network interfaces and connectivity, and specifically to systems and methods for connecting disparate computing devices and networks via shared, standard interfaces and direct network connections between devices and networks.

### Description of the Related Art

The importance of offline-to-offline (O2O) markets gradually grows with the constant expansion of e-commerce transaction platforms and online payment services. People find that the “housing component” among the four components of “clothing, food, housing, and transportation” is the most important component and that people's pursuit of better tourism service quality has risen to new heights. In this case, the future hotel industry should be upgraded in terms of technical equipment, marketing models, operational efficiency, service concept, and the like, in order to meet consumers' expectations and improve competitiveness.

Some existing e-commerce platforms can provide “online room reservation and offline check-in” services. However, these platforms suffer from numerous deficiencies. The first problem is inconvenient payment procedures. The conventional reservation process and online reservation process require a user to pay more than the cost of the room (e.g., a deposit by pre-authorization of a credit or debit card, an online payment tool, or the like). The procedure is very complex, and costs the user money. In addition, due to the geographical location of the hotel and poor cellular signal, users may be unable to normally use an online payment tool due to network problems when the user uses the online payment tool within a hotel. This problem is also highlighted in current O2O techniques. Another problem is low working efficiency of the hotel reception desk. Generally, users check in, check out, or perform other procedures at the reception desk in concentrated times. The current method of using a credit/debit card is low in efficiency and requires users to wait for processes such as swiping the card and signature; as a result, the users generally wait for a long time. Therefore, hotels using current systems and techniques are inefficient and provide a poor user experience.

### BRIEF SUMMARY

The present application provides a data object information processing method, apparatus and system. The method, apparatus and system improves the efficiency and prevents a user from waiting in a line. The method, apparatus and system can also reduce direct interaction between the user and the staff of a hotel, increase online services, and reduce operational costs of the hotel.

In one embodiment, the method comprises providing, by a platform server, hotel data object information to a client device, the hotel data object information including a plurality of type attributes including a credit type attribute; receiving, at the platform server, a reservation request from the client device, the reservation request including an identification of the credit type attribute; verifying, by the platform server and in response to the reservation request, a credit authorization of a user associated with the client device; generating, by the platform server, a credit-type booking upon verifying the credit authorization; transmitting, by the platform server, booking information associated with the credit-type booking to a hotel data processing system associated with a hotel; receiving, at the platform server, a check-out request from the hotel data processing system; and transferring, by the platform server, resources associated with the booking information from a payment account associated with the user to the hotel data processing system upon receiving the check-out request.

In one embodiment, the apparatus includes a processor and a non-transitory memory storing computer-executable instructions therein that, when executed by the processor, cause the apparatus to perform the operations of providing hotel data object information to a client device, the hotel data object information including a plurality of type attributes including a credit type attribute; receiving a reservation request from the client device, the reservation request including an identification of the credit type attribute; verifying, in response to the reservation request, a credit authorization of a user associated with the client device; generating a credit-type booking upon verifying the credit authorization; transmitting booking information associated with the credit-type booking to a hotel data processing system associated with a hotel; receiving a check-out request from the hotel data processing system; and transferring resources associated with the booking information from a payment account associated with the user to the hotel data processing system upon receiving the check-out request.

According to specific embodiments provided by the present application, the present application discloses the following technical effects.

As illustrated in the disclosed embodiments, a platform may be provided with a server and a client device. In one embodiment, the server can be directly connected to a hotel data processing system. In this way, a user can reserve a hotel room with the client device. After generating a booking, the server may directly provide the booking to the hotel data processing system through a direct connection. In addition, a data object of the hotel may have a credit-type attribute. If the user selects the credit type, the server may verify credit authorization of the user, and may generate a credit-type booking when the verification succeeds. In this way, the hotel may provide credit-type based services such as check-in without a deposit and/or check-out without a room check. After the user checks out of the hotel, the server transfers resources related to the booking from a payment account of the user to the hotel. The disclosed embodiments improve efficiency and prevent the user from waiting in line. In addition, the disclosed embodiments can also reduce direct interactions between the user and hotel staff, enhance online services, and reduce operational costs of the hotel.

Moreover, by means of various types of function options, new functions such as having the invoice prepared beforehand, online room selection, intelligent door lock, self-check-in, room service, interactive marketing, and room control may be implemented. The hotel will be able to create innovative reservation, check-in, and service experiences, providing smooth interactions between the user and the hotel. Hotel competitiveness can be improved by outputting platform data, services, solutions, and the like. A hotel can then be quickly integrated into the “Internet+” era.

Any product that implements the disclosed embodiments does not necessarily have to achieve all the above advantages at the same time.

### BRIEF DESCRIPTION OF THE DRAWINGS

In order to clearly illustrate the technical solution in the embodiments of the present application, the drawings required in the embodiments will be introduced briefly below. It is apparent that the drawings described below are merely some embodiments of the present application, and those of ordinary skill in the art can also obtain other drawings according to these drawings without making creative efforts.

FIG. 1 is a block diagram illustrating a system for processing data objects according to some embodiments of the disclosure.

FIG. 2 is a flow diagram illustrating a method for processing data objects according to some embodiments of the disclosure.

FIG. 3 is a flow diagram illustrating a method for processing data objects according to some embodiments of the disclosure.

FIG. 4 is a flow diagram illustrating a method for processing data objects according to some embodiments of the disclosure.

FIG. 5 is a block diagram of an apparatus for processing data objects according to some embodiments of the disclosure.

FIG. 6 is a block diagram of an apparatus for processing data objects according to some embodiments of the disclosure.

FIG. 7 is a block diagram of an apparatus for processing data objects according to some embodiments of the disclosure.

### DETAILED DESCRIPTION

The technical solutions described in the embodiments of the disclosure are described clearly and completely below with reference to the drawings in the embodiments of the present application. The described embodiments are merely some, rather than all of the embodiments of the disclosure. Based on the embodiments in the present application, all other embodiments obtainable by those of ordinary skill in the art shall fall within the scope of the disclosure.

In the disclosed embodiments, an e-commerce platform may be connected to a data processing system inside a hotel (e.g., a property management system), wherein the e-commerce platform may be implemented as one or more servers and a client device provided for a user. In one embodiment, if a hotel needs to issue a hotel service using the e-commerce platform, the e-commerce server may establish a connection with the data processing system of the hotel in advance and provide the hotel data processing system information such as a standard interface of a server terminal. Likewise, the hotel data processing system may also provide interface information thereof to the e-commerce platform, thus implementing a direct-connection between the platform server and the hotel data processing system. On the other hand, the hotel may publish information such as its address, room types, and required resources (such as prices) to the e-commerce platform. The e-commerce platform publishes information regarding the hotel in the form of a “data object” (e.g., at the e-commerce platform, a data object may be referred to as a “commodity”, “service”, “business”, etc., and each data object may correspond to one item when being presented with codes), such that the consumer user may view reservable hotel room information via the e-commerce platform using the client device. In one embodiment, the server may provide support in terms of “credit stay.” A “credit stay” refers to the following scenario: when a user books a hotel room online with a client device, the user may select a “credit stay” booking type. The server may verify credit authorization of the user; and if the user's credit meets a business condition, the user does not need to pay a room fee when using an online payment. The hotel may provide a deposit-free check-in for the user according to the “credit stay” identification of the booking; and the user may directly check out without having the room checked or waiting in line and may leave the hotel directly. Finally, the server transfers the room fee from a payment account associated with the user to the hotel. Regarding payment of the room fee, as the user and the hotel may open payment accounts at the e-commerce platform (for example, in the TAOBAO platform, ALIPAY accounts may be used; or associated bank accounts may be used, etc.), the hotel data processing system may provide the specific spending amount to the server when initiating and sending a check-out request to the server; in this way, the server may transfer a corresponding amount from a payment account of the user to a receipt account of the hotel.

Additional functions may be derived based on the above basic functions to implement an online interaction between the user and the hotel, relieving the hotel staff and improving the efficiency and service capability of the hotel. Meanwhile, more ways of offering services are provided for the hotel, enabling users to experience convenience brought by technology and the Internet during their hotel stay. For example, a function option of canceling a booking, a function option of confirming whether a user can arrive to the hotel on time, a function option of initiating a booking type conversion, function options such as check in, check out, and account settlement, and the like may be provided for the hotel. In addition, function options such as online room selection, online unlocking service, self-check-in, online issuing of business receipts, and online applications for another service provided by the hotel (e.g., a dining service, a laundry service, a cleaning service, a goods service, a maintenance service, etc.) may further be provided to the user. In this way, smooth interactions between the user and the hotel are enabled. Moreover, hotel competitiveness can be improved by outputting e-commerce platform data, services, solutions, and the like. Therefore, a hotel can then be quickly integrated into the “Internet+” era.

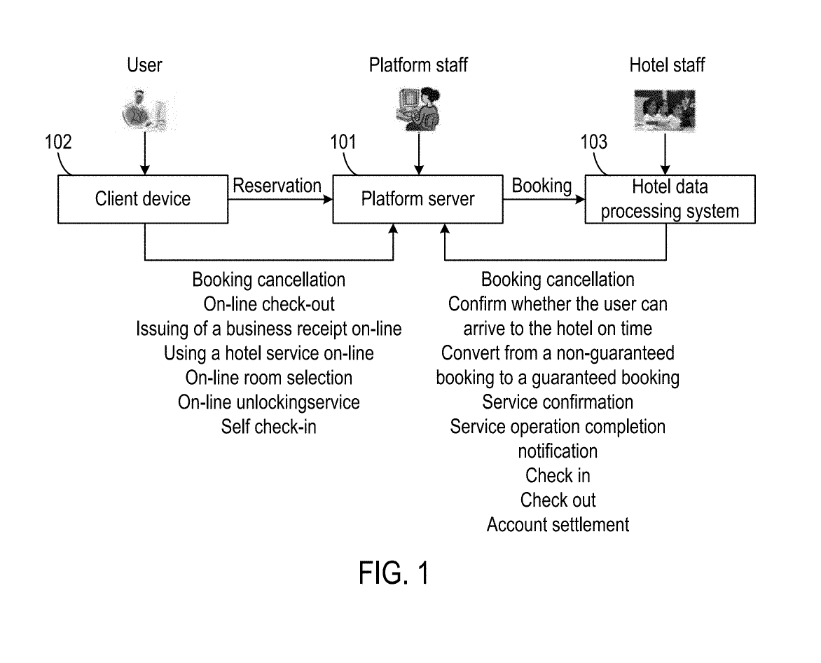

FIG. 1 is a block diagram illustrating a system for processing data objects according to some embodiments of the disclosure. Referring to FIG. 1, the system includes: a platform server 101; at least one client device 102; and at least one hotel data processing system 103 (only one is shown in the drawing).

In one embodiment, the platform server 101 (1) provides hotel data object information to the client device, the hotel data object having type attributes including a credit type; (2) verifies credit authorization of a user associated with the client device upon receiving a reservation request from the client device; (3) generates a credit-type booking if the verification succeeds; (4) sends booking information to the hotel data processing system via an interface of the hotel data processing system; and (5) transfers resources (e.g., room fees) associated with the booking from a payment account associated with the user to a receipt account associated with the hotel after the user checks out of the hotel. In one embodiment, the client device 102 sends the reservation request to the platform server upon selecting a target data object and a type. In one embodiment, the hotel data processing system 103 receives a booking from the platform server and provides a credit-type service for the user according to a predetermined manner during a hotel stay of the user associated with the booking.

In some embodiments, a credit-type booking may include a “credit stay” booking or similar bookings. In a credit stay booking, after the user checks in and stays at the hotel, the user does not pay for the room charge or a deposit. Therefore, the hotel provides offline services (e.g., rooms, dining services, laundry services, cleaning services, goods services, and maintenance services, etc.) for the user based on a credit endorsement provided by the platform server for the user and the platform server assists in the completion of a payment operation after the user finishes using the offline services. In other words, the user uses the offline services before paying a deposit and payment can be made afterwards; this is therefore referred to as a “credit-type booking” or “credit stay.”

Regarding the type attribute of the data object, the credit type described herein is a new type relative to the conventional manners such as online payment and payment upon arrival. The user may choose to make a booking using a traditional means; or a way of making a booking may be provided for a new user or a user having credit information that does not satisfy a business condition. In one embodiment, an option of generating a “conventional way of consumption” may further be provided. Therefore, the conventional type and the credit type may be referred to as different type attribute values; and by means of the type attribute, various types may be provided for the user to select. If the user selects the credit type, credit authorization is verified according to the manner provided in disclosed embodiments; and after a credit-type booking is generated, the hotel may provide a deposit-free service, a room check-free service when checking out, etc. If the user selects to book a room using a conventional manner, an ordinary booking may be generated for the user according to the conventional manner.

It should be noted that the hotel may select to support or not support the credit type. In other words, in the process of the hotel entering a platform, functions provided by the server may be configured for use. For the hotel selecting to use the credit type function, the server provides an option for generating a credit-type booking when the hotel issues data object information thereof.

When the user makes a booking using a client device, if the user selects a hotel and selects a “credit type” booking, the server may first receive the request and verify credit authorization of the current user according to a preset business condition. There may be a variety of specific verification methods, and the specific business condition may be determined according to actual business requirements. For example, a user's credit level, credit limit, number of unsettled bookings, etc. may be utilized. In this way, for various parameters involved in the business condition, when performing a determination specifically, the server may determine a parameter value corresponding to the current user. The server then compares the parameter value with a threshold and the like set in the condition, thereby further determining whether the user meets the business condition. For example, in the ALITRIP platform, information of “ZHIMA CREDIT” associated with an ALIPAY account of a user may be acquired, and “MAYI HUABEI” may further be acquired as credit limit information provided by a second user. In addition, the number of unsettled bookings associated with the ALIPAY account may further be determined, etc. All the above factors may be used to determine whether the current user meets the business condition. If the user meets the condition, a booking may be generated, and the type of the booking is marked as a credit-type booking.

After the credit-type booking is generated, booking information may be provided to the client device. As the server acquires a relevant interface of the hotel data processing system in advance, the server may directly provide the booking information to the hotel data processing system via a direct connection. When the user arrives to the hotel and checks in, the user may turn on the client device and provide the booking information. After confirming that the booking is a credit-type booking, the hotel may provide a credit-type service for the user according to a preset manner. The credit-type service may refer to the following scenario: when the user checks in, the user does not need to pay a deposit; or when the user checks out of the hotel, room check does not need to be conducted, thus preventing the user from waiting in a line. In addition, the user does not need to pay for the room charge during or after the hotel stay of the user; instead, the server transfers the payment of the room charge between accounts. In some embodiments, the hotel data processing system may further synchronize a booking status with the server. For example, after the user checks in with a deposit-free method, the hotel data processing system may modify the booking status to “checked in”, and submit it to the server. Subsequently, when the user checks out of the hotel, the user may check out without having the room checked; and the hotel data processing system may modify the booking status as “checked out” and submit it to the server. In addition, information such as resources (such as the amount spent) associated with the booking may be submitted, and the server may transfer corresponding resources from a user's payment account of the platform to a receipt account of the hotel.

In addition, based on providing the basic “credit stay” service in the above, the server may further provide a “function option” for a processing operation of the booking to facilitate the processing operation of the booking in a life cycle of the booking.

Specifically, depending on the objects targeted, the function option may be classified into: at least one first function option provided for the hotel data processing system and used for a processing operation of the booking, and at least one second function option provided for the client device and used for a processing operation of the booking. The first function option may be provided to the hotel data processing system along with the booking; and the hotel data processing system may initiate and send, with the first function option, a request for a processing operation of a specified booking to the server. Correspondingly, the server may process the request of the hotel data processing system accordingly. The second function option may be provided to the user via a user interface of the user's client device. The user may initiate an operation request with the second function option in the client device. The client device may submit the request to the server, and the server processes the user's request accordingly.

A first function option provides a feasible way for the hotel data processing system to actively initiate a booking operation or for interacting with the user, and may be provided according to an actual requirement specifically. For example, in one embodiment, the hotel data processing system may need to cancel a booking; the server may therefore provide a first function option used for canceling a booking for the hotel data processing system. In this way, if the hotel needs to initiate a cancellation of the booking, the hotel may initiate the cancellation with the function option provided by the server. Correspondingly, the information may be submitted to the server via a pre-acquired, standard interface of the server. The server specifically performs a relevant operation of the booking cancellation. The server may return the final processing result to the hotel data processing system. In addition, the user may be further notified of the processing result. When performing the canceling operation of the booking, the server may first initiate and send a confirmation check to the client device of the user and the cancellation operation may be performed when the user confirms that the booking can be canceled.

In another embodiment, the hotel may further need to confirm whether a user can arrive to the hotel on time. For example, when booking a hotel room online, a user may specify a check-in date without paying any fee beforehand. In this case, if the user fails to arrive on time to fulfill a booking, the hotel may have to bear the loss. Such a case may also affect other guests/users' reservation privileges. Therefore, for this type of booking, the hotel may need to confirm whether the user can arrive to the hotel on time. If the user fails to arrive on time to fulfill a booking, the hotel can initiate a canceling operation of the booking or the like, so as to free up the room for other users; and if the user can arrive on time, the room may remain reserved for the user. In current solutions, the hotel often needs to contact the user manually using the telephone number left by the user; and this obviously takes up some resources of the hotel. However, in the embodiments of the disclosure, the hotel data processing system has a function option for confirming whether the user can arrive to the hotel on time. An arrival time confirmation request may be initiated directly using the option. Accordingly, after receiving the request, the server may send a query message to the client device associated with the specified booking requesting confirmation of the user's arrival, and provide the result (including the information of whether the user will arrive to the hotel on time) returned by the client device to the hotel data processing system. In this way, resources of the hotel may be saved, and the processing efficiency may be improved.

In addition, the hotel may need to convert the booking types. Here, the booking type conversion function option mainly refers to convert the booking from a non-guaranteed booking to a guaranteed booking. The so-called non-guaranteed booking refers to the situation where a user books a hotel room online and specifies a check-in date without paying any fee beforehand. The guaranteed booking, on the other hand, refers to the situation where a user books a hotel room online and pays a deposit as required by the hotel when the user chooses a specific check-in date; and in this case, if the user cannot make it to the check-in on time, the deposit will not be returned, preventing the hotel from any no-show loss. If the user checks in on time, the deposit is returned to the user when the user checks out of the hotel (the process is a conventional guarantee process; and in the embodiment of the present application, the existing guarantee process may be improved, which will be described in detail subsequently). For example, the above scenario where confirming check of whether the user can arrive to the hotel on time also applies to a non-guaranteed booking; on the same day or a day before the check-in date specified by the user, the hotel normally needs to find out whether the user can arrive to the hotel on time. If the user cannot be sure whether he/she can arrive to the hotel on time but still requires the hotel to reserve the room, the hotel may need to convert the non-guaranteed booking into a guaranteed booking, preventing the hotel from any no-show loss. In this scenario, the hotel data processing system may initiate a corresponding request by using the second function option, provided by the server, for performing a booking type conversion. After receiving the request, the server may convert the specified booking to a guaranteed booking, and provide the conversion result to the hotel data processing system.

Other relevant operations may also be performed when a non-guaranteed booking is specifically converted to a guaranteed booking. If the booking is guaranteed in a conventional manner, the server may, for example, further assist the user to complete a deposit payment during the booking conversion. Conventional guaranteeing methods have numerous deficiencies. First, the user needs to pay a deposit in advance, which affects the user's available capital. Further, normally the user's information on payment account will need to be provided to the hotel. Some hotels in China support many payment methods, including using a credit/debit card, ALIPAY, or another third-party payment tool, etc. Some international hotels, on the other hand, only support the credit/debit card payment method. No matter which payment method is used, account information of the user is provided to the hotel, leading to security risks during the payment. Additionally, the operation process is relatively complex, and the efficiency is low. A reverse process will be necessary to return the deposit to the account of the user if the user checks in on time. The whole process leads to a waste of the network resources. Therefore, in one embodiment, to further optimize the guarantee process, a new guaranteed booking processing method is disclosed. When a user makes a guaranteed booking online, if the user is a credited user meeting the business condition (discussed previously), the server directly marks the booking as a guaranteed booking without needing the user to pay the relevant deposit. If the user is not able to arrive to the hotel and check in on time, the server transfers the amount of the relevant deposit from the payment account of the user to a receipt account of the hotel. In this way, unnecessary holding of a user's money may be avoided, and overall processing efficiency may be improved. Moreover, the account information of the user does not need to be provided to the user; as a result, potential security risks of the user information are eliminated. Thus, in this guaranteeing method, when a server receives the booking conversion request from the hotel data processing system, it may directly mark the corresponding booking as a guaranteed booking without having to perform any other guarantee-related operations. If the user arrives to the hotel and checks in on time, the server and the hotel do not need to perform any operations; and if the user does not check in on time, the server then performs the operation of transferring the deposit.

In addition to the various first function options describing above, operation function options such as check-in, check-out, account settlement, and service operation completion notification function options may also be included. When the check-in function option is selected, the hotel data processing system may modify the booking status as “checked in” and provide the status information to the server wherein the server modifies the booking status simultaneously. When the check-out function option is selected, the hotel data processing system may modify the booking status as “checked out” and provide the status information to the server wherein the server modifies the booking status simultaneously. When the account settlement function option is selected, the hotel data processing system may provide the server information such as the spending amount associated with the booking. The server performs the operation of transferring the spending amount. The service operation completion notification option is used for notifying the server that a service operation has been completed; and the server may forward the notification to the client device, and the like.

In alternative embodiments, other function options may be provided for the hotel data processing system according to the requirements of the hotel data processing system, which are not described in detail herein.

Types of second function options are introduced below.

The second function option provides a feasible way for the user to actively initiate a booking operation or for interacting with the hotel data processing system, and may be provided according to actual requirements. First, the server may provide a function option of online check-out for the user. Through this function option, the user may initiate a check-out request online. The request may first reach the server; and the server then forwards the request to the hotel data processing system.

Alternatively, or in conjunction with the foregoing, normally a user might have the need for a business receipt (such as an invoice). In current solutions, generally when a guest checks out of the hotel, the guest notifies a receptionist requesting that the invoice (amount, title, and the like) be prepared. The receptionist issues the invoice and hands the invoice to the guest. However, when a guest checks out at the front desk but has to wait for the reception desk to issue the invoice, it will be quite time consuming if the reception desk is understaffed or many guests are waiting for the same purpose at the same time. Such a waiting scenario might even result to a guest's missing of a plane, a train, and so on. In the hotel industry, the check-out procedure usually needs to be done before noon or before 2 PM. The hotel may charge an additional fee if guests fail to do so. As a result, the guests may all like to have the check-out done in the morning, which causes the receptionists to be very busy after 8 AM. In addition, in the process that the receptionist issues an invoice, generally a memo needs to be printed and an invoice is then printed by the receptionist after the customer confirms that the memo is correct at the reception desk. This procedure needs back and forth communication and waiting, and consumes a lot of time. Where many guests are checking out and waiting for their invoices, the last guest in the line will have to wait for a long time, which might affect this guest's subsequent travel itinerary.

To address this, the server may further provide a function option for issuing a business receipt for the user. The function option is normally switched to an operable status after the booking enters the “checked in” status. In this way, the user may initiate a request of issuing a business receipt prior to checking out of the hotel. The server then forwards the request to the hotel data processing system. The staff of the hotel may perform any relevant operations of issuing the business receipt in advance; print the invoice and send the invoice to the room if needed; keep the invoice at the reception desk; and mail it to the user, etc. Having to wait for the business receipt to be issued at the reception desk during a busy time can then be avoided, thereby improving the processing efficiency and saving time for a second user. For the first user, the requests of issuing business receipts may be handled at different times, thereby the service quality is improved. The platform providing the service may further improve the varieties of services and information.

Because the user employs a credit consumption method without paying any fee before checking in, the spending amount changes constantly as the number of days increases. Therefore, the user may need to find out his/her current spending amount. In current solutions, normally the user can talk to the reception desk by himself/herself, or query by making a telephone call, or the like. However, in one embodiment, the server may provide in the user interface of the client device a function option for querying the current spending amount. In this way, the user may initiate a request with the client device when such needs arise. The server may send to the hotel data processing system the received request for querying a spending amount for a specified booking, and provide the query result returned by the hotel data processing system to the client device.

During the hotel stay of the user, the hotel may often provide other related concierge services to make their guests' stay more enjoyable, such as a dining service, a laundry service, a cleaning service, a goods service, and a maintenance service. In current solutions, these services are made available after the user makes a phone call to the reception desk, or visits the receptionist in person. However, in one embodiment, a function option for using concierge services provided by the hotel may be provided in the user interface of the client device. After receiving a request of using a concierge service for a specified booking, the server may send the request to the hotel data processing system. The hotel data processing system will then allocate corresponding resources (including human and material resources) to provide a corresponding service for the associated user.

In addition, more intelligent second function options may be provided to further enhance the intelligence of the system, including online room selection, online unlocking service, self-check-in, etc. As for the room selection, the user can only select a room type, i.e., a standard room, a business room, or the like in current solutions. The specific room number, however, will only be allocated by the receptionist when the user checks in. The user can only check in by accepting what is offered. If the user is not satisfied with the allocated room, further communication with the receptionist for room change is needed; thus, resulting in low efficiency and poor user experience. However, in one embodiment, the server may provide an online room selection function option for the user. If the user needs to select a room online, the user may initiate a request with this option. The server may provide the client device an online room selection interface according to indoor/outdoor map data of the hotel and the pre-acquired real-time room reservation information from the hotel data processing system; add the selection result submitted by the client device to the booking; and provide the booking to the hotel data processing system. By means of this online room selection, the user may select a room online that meets the user's needs. Moreover, the selection is not limited to the room type; selection options include room number, in which direction it faces, on which floor it is located, and the like are also available. In some embodiments, basic data information such as room detail information of the hotel may be provided by the hotel and the platform server generates map data accordingly to be provided to the client device of the user. The room selection requirement usually arises after the user determines a check-in date. Therefore, after the user selects a room, the server may record the selected room and associated check-in date information. The information may be used as the real-time reservation information of the hotel rooms. When a subsequent online room selection request of another user is received, rooms that have not been reserved on the check-in date may be provided for the user.

The online unlocking service refers to the following situation: when a user checks in at a hotel, the user may submit identity authentication information directly with a client device. The server verifies the identity information and sends the verification result to the hotel data processing system if the verification succeeds. After viewing the verification result, the receptionist may send information such as a room card and a room password to the user. In addition, functions like automatic elevator control, automatic power off, and the like may further be performed. Various types of identity authentication information are available. For example, in one embodiment, the identity authentication information may be facial scan information of the user. In other words, after the user uses the online unlocking function option, the client device may open an image capturing device on the client device to scan the user's face and upload the scan information to the server. The server may be connected to a system such as the public security department, and retrieve an identity card photo associated with an identity card number from the public security system according to pre-stored information such as the real name of the user and the ID number. The server then compares the received facial scan result with the identity card photo, and verifies the identity authentication information of the user based on the comparison result. The verification may further be performed in other ways, such as fingerprint and iris comparisons.

Another scenario is after the user checks in and needs to find the allocated room, the user will have a hard time locating the room if many rooms exist in the hotel and the floor plans are complex. In this case, the server may further provide a function option of self-check-in for the user. The user may perform the operation provided by the function option. After receiving a request from the client device, the server may provide navigation information for the client device according to the pre-stored indoor/outdoor map data of the hotel and a room allocation result associated with the booking. It should be noted that when the terminal device is low in positioning precision (for example, it may have an error of about 10 meters), the user may be notified of a specific position through a voice reminder. For example, the user is prompted to turn left or right after leaving the elevator; go straight for a certain distance and then turn left or right, or the like. When the positioning precision is high, dynamic real-time navigation may be performed. That is, the user is prompted to turn left, right, or the like along with the actual traveling position of the user.

Various function options provided by the server are introduced above to implement interaction between the hotel and the user, thereby reducing the needed workforce, improving the processing efficiency, and improving the user experience. In practice, the above functions may further be expanded according to actual needs, which are not limited herein. In addition, in the process of connecting to the platform, the hotel may further configure different functions, i.e., choose to use or not to use some function options. For example, some hotels may not have a dining service or a maintenance service; and the hotels may choose not to use these function options. Or, some hotels may not accept a guaranteed booking; and the hotels may choose not to use the booking type conversion function option, or the like. In brief, the server may store configuration information of the hotel, and merely provide the client device function options chosen to be used by the hotel data processing system when providing data object information to the client device. Therefore, the situation where the user selects a certain function option but the hotel cannot meet the requirement can then be avoided.

In brief, with the system provided according to the disclosed embodiments, a platform may be provided with a server and a client device, wherein the server can be directly connected to a hotel data processing system. In this way, a user can reserve a hotel room with the client device. After generating a booking, the server may directly provide the booking to the hotel data processing system through the direct connection. In addition, a data object of the hotel may have a credit-type attribute. If the user selects the credit type, the server may verify credit authorization of the user, and may generate a credit-type booking when the verification succeeds. In this way, the hotel may provide credit-type based services such as check-in without a deposit and check-out without a room check. After the user checks out of the hotel, the server transfers resources related to the booking from a payment account of the user to the hotel. This manner improves efficiency, and prevents the user from waiting in line. Moreover, a smooth interaction between the user and the hotel is implemented via various function options. The hotel competitiveness can be improved by outputting platform data, services, solutions, and the like. A hotel can then be quickly integrated into the “Internet+” era.

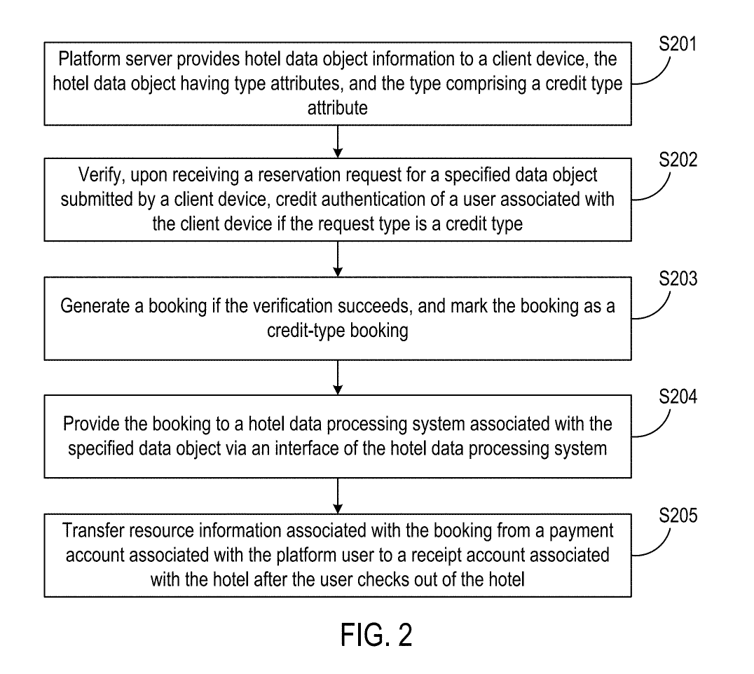

The embodiments discussed in connection with FIG. 1 mainly introduce the technical solution provided by the disclosed embodiments from a system-level perspective. However, as described in connection with FIG. 2, various methods are disclosed from the perspective of a server.

FIG. 2 is a flow diagram illustrating a method for processing data objects according to some embodiments of the disclosure. Referring to FIG. 2, the illustrated embodiment provides a data object information processing method. The method may include the following steps.

S201: provide, by a platform server, hotel data object information to a client device, the hotel data object having type attributes, and the type attributes including a credit type attribute.

S202: verify, upon receiving a reservation request for a specified data object submitted by a client device, credit authorization of a user associated with the client device if the request type is a credit type.

S203: generate a booking if the verification succeeds, and mark the booking as a credit-type booking.

S204: provide the booking to a hotel data processing system associated with the specified data object via an interface of the hotel data processing system, so as to provide the credit-type service for the user according to a predetermined manner during a hotel stay of the user associated with the booking.

S205: transfer resources associated with the booking from a payment account associated with the platform user to a receipt account associated with the hotel after the user checks out of the hotel.

In addition, a function option for a processing operation of the booking may be further provided for the client device and/or the hotel data processing system to facilitate the processing operation of the booking during a life cycle of the booking, as discussed in connection with FIG. 1, thus achieving a smooth interaction between the user and the hotel.

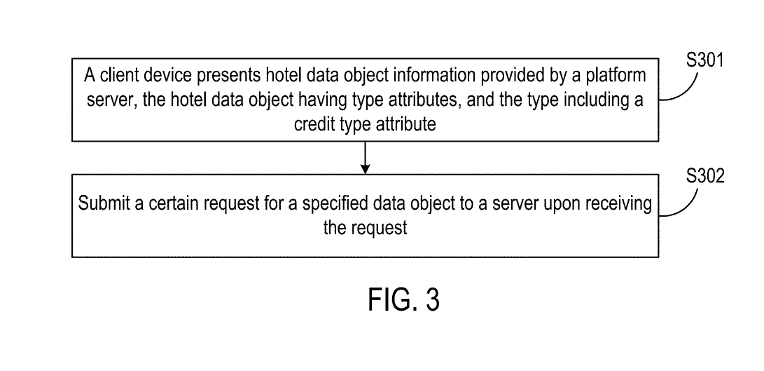

FIG. 3 is a flow diagram illustrating a method for processing data objects according to some embodiments of the disclosure. The embodiment illustrated in FIG. 3 provides a data object information processing method from the perspective of a client device. Referring to FIG. 3, the method may include the following steps.

S301: present, by a client device, hotel data object information provided by a platform server, the hotel data object having type attributes, and the type comprising a credit type attribute.

S302: submit a reservation request for a specified data object to the server upon receiving the request, such that the server verifies credit authorization of a user associated with the client device when the request type is a credit type; generates a booking if the verification succeeds and marks the booking as a credit-type service booking; provides the booking to a hotel data processing system associated with the specified data object via an interface of the hotel data processing system, so as to provide the credit-type service for the user according to a predetermined manner during the hotel stay of the user associated with the booking; and transfers resources associated with the booking from a payment account associated with the user to a receipt account associated with the hotel after the user checks out of the hotel.

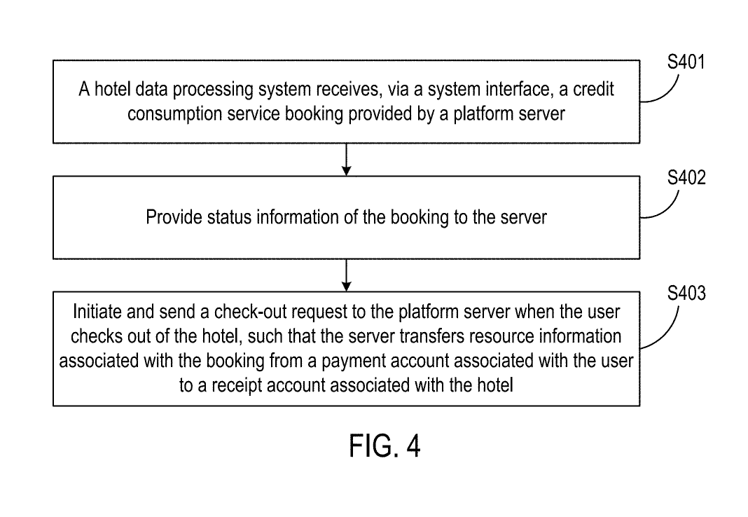

FIG. 4 is a flow diagram illustrating a method for processing data objects according to some embodiments of the disclosure. The embodiment illustrated in FIG. 4 provides a data object information processing method from the perspective of a hotel data processing system. Referring to FIG. 4, the method may include the following steps.

S401: receive, by a hotel data processing system via a system interface, a credit consumption service booking provided by a platform server. In some embodiments, the booking is generated in the following manner: the server verifies, upon receiving a reservation request for a specified data object submitted by a client device, credit authorization of a user associated with the client device if the request type is a credit type, generates a booking if the verification succeeds, and marks the booking as a credit-type service booking.

S402: provide status information of the booking to the server.

S403: initiate and send a check-out request to the platform server when the user checks out of the hotel, such that the server transfers resources associated with the booking from a payment account associated with the user to a receipt account associated with the hotel.

It should be noted that, the embodiments illustrated in FIGS. 2 through 4 correspond to the functionality and methods described in connection with FIG. 1. Therefore, relevant technical implementation details may therefore be obtained by referring to the description of the embodiments in FIG. 1, and are not repeated herein but are incorporated by reference in their entirety.

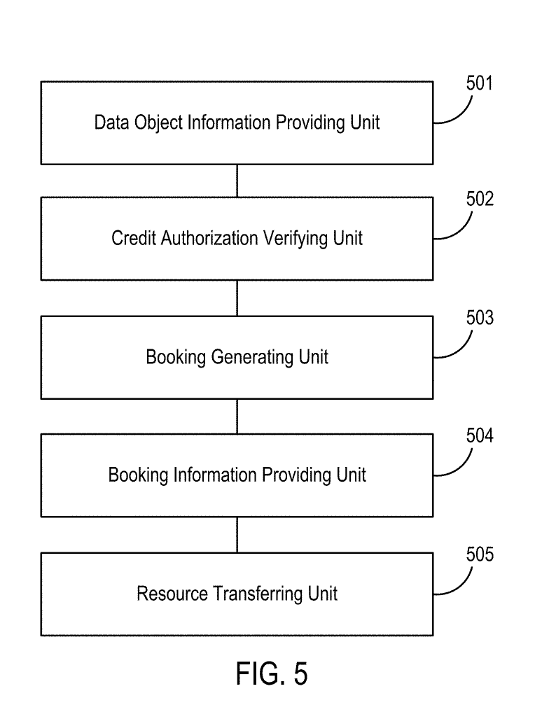

FIG. 5 is a block diagram of an apparatus for processing data objects according to some embodiments of the disclosure.

As illustrated in FIG. 5, the disclosure further provides a data object information processing apparatus, applicable to a platform server. Referring to FIG. 5, the apparatus includes a data object information providing unit 501 that provides hotel data object information to a client device. In one embodiment, the hotel data object includes one or more type attributes, the type including a credit type attribute.

In the illustrated embodiment, the apparatus further includes a credit authorization verifying unit 502 that verifies, upon receiving a reservation request for a specified data object submitted by the client device, credit authorization of a user associated with the client device if the request type is a credit type.

In the illustrated embodiment, the apparatus further includes a booking generating unit 503 that generates a booking if the verification succeeds, and marks the booking as a credit-type service booking.

In the illustrated embodiment, the apparatus further includes a booking information providing unit 504 that provides the booking to a hotel data processing system associated with the specified data object via an interface of the hotel data processing system, so as to provide the credit-type service for the user according to a predetermined manner during a hotel stay of the user associated with the booking.

In the illustrated embodiment, the apparatus further includes a resource transferring unit 505 that transfers resources associated with the booking from a payment account associated with the user to a receipt account associated with the hotel after the user checks out of the hotel.

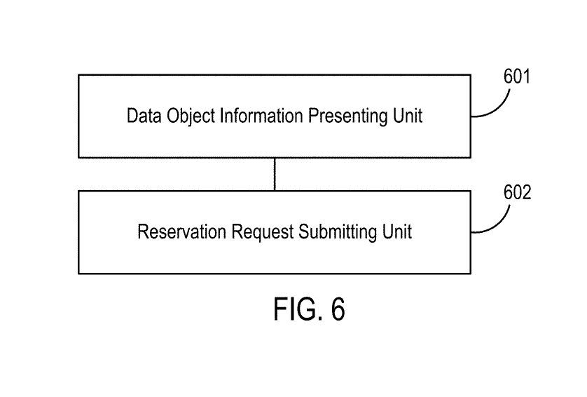

FIG. 6 is a block diagram of an apparatus for processing data objects according to some embodiments of the disclosure.

As illustrated in FIG. 6, the disclosure further provides a data object information processing apparatus, applicable to a client device.

In the illustrated embodiment, the apparatus illustrated in FIG. 6 includes a data object information presenting unit 601, configured to present hotel data object information provided by a platform server, the hotel data object having type attributes, and the type comprising a credit type;

In the illustrated embodiment, the apparatus illustrated in FIG. 6 includes a reservation request submitting unit 602, configured to submit a reservation request for a specified data object to a server upon receiving the request, such that the platform server verifies credit authorization of a user associated with a client device when the request type is the credit type; generates a booking if the verification succeeds and marking the booking as a credit-type service booking; provides the booking to a hotel data processing system associated with the specified data object via an interface of the hotel data processing system, so as to provide the credit-type service for the user according to a predetermined manner during a hotel stay of the user associated with the booking; and transfers resources associated with the booking from a payment account associated with the user to a receipt account associated with the hotel after the user checks out of the hotel.

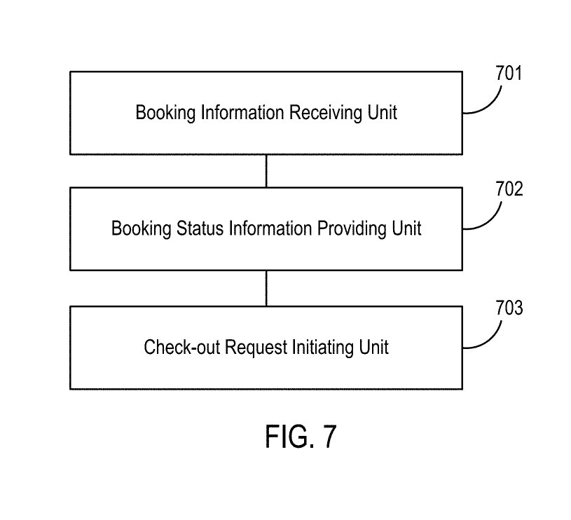

FIG. 7 is a block diagram of an apparatus for processing data objects according to some embodiments of the disclosure.

As illustrated in FIG. 7, the disclosure further provides a data object information processing apparatus, applicable to a hotel data processing system. Please refer to FIG. 7.

The apparatus illustrated in FIG. 7 includes a booking information receiving unit 701, configured to receive, via a system interface, a credit consumption service booking provided by a platform server, the booking being generated in the following manner: the server verifying, upon receiving a reservation request for a specified data object submitted by a client device, credit authorization of a user associated with the client device if the request type is a credit type, generating a booking if the verification succeeds, and marking the booking as a credit-type service booking.

The apparatus illustrated in FIG. 7 includes a booking status information providing unit 702, configured to provide status information of the booking to the server.

The apparatus illustrated in FIG. 7 includes a check-out request initiating unit 703, configured to initiate and send a check-out request to the platform server when the user checks out of the hotel, such that the server transfers resources associated with the booking from a payment account associated with the user to a receipt account associated with the hotel.

By means of the disclosed embodiments, a platform may be provided with a server and a client device. The server can be directly connected to a hotel data processing system. In this way, a user can reserve a hotel room with the client device. After generating a booking, the server may directly provide the booking to the hotel data processing system through a direct connection. In addition, a data object of the hotel may have a credit-type attribute. If the user selects the credit-type, the server may verify credit authorization of the user, and may generate a credit-type booking when the verification succeeds. In this manner, the hotel may provide credit-type based services such as check-in without a deposit and check-out without a room check. After the user checks out of the hotel, the server transfers resources related to the booking from a payment account of the user to the hotel. The disclosed embodiments improve efficiency, and prevent a user from waiting in line. In addition, the disclosed embodiments can also reduce direct interactions between the user and the staff of the hotel, enhance online services, and reduce operational costs of the hotel.

Through the foregoing description of the implementations, those skilled in the art can clearly understand that the disclosed embodiments can be implemented by software plus a necessary universal hardware platform. Based on such understanding, the technical solution of the disclosed embodiments essentially, or the portion contributing to the prior art may be embodied in the form of a software product. The software product may be stored in a storage medium, such as a ROM/RAM, a magnetic disk, or an optical disc, and include several instructions that enable a computer device (which may be a personal computer, a server, a network device, or the like) to execute the method in the embodiments or certain portions of the embodiments of the disclosure.

Various embodiments in the specification are described in a progressive manner. The same or similar parts between the embodiments may be referenced to one another. In each embodiment, the portion that is different from other embodiments is focused and described. Especially, with regard to the system or system embodiment, since they are substantially similar to the method embodiments, the description is relatively simple, and reference can be made to the description of the method embodiments for related parts. The system and system embodiment described in the above are merely exemplary, where units described as separate parts may be or may not be physically separate, and the parts shown as units may be or may not be physical units, and not only can be located in one place, but also can be distributed onto a plurality of network units. Part or all of the modules can be chosen to implement the objective of the embodiment schemes according to actual requirements. Those of ordinary skill in the art may understand and implement the disclosed embodiments without creative efforts.

Hereinbefore, a data object information processing method, apparatus and system provided in the disclosed embodiments are introduced in detail, the principles and implementation manners of the disclosed embodiments are set forth herein with reference to specific examples, descriptions of the above embodiments are merely served to assist in understanding the method and essential ideas of the disclosed embodiments; and to those of ordinary skill in the art, changes may be made to specific implementation manners and application scopes according to the ideas of the disclosed embodiments. In view of the above, the content of the specification should not be construed as limiting the disclosed embodiments.

What is claimed is:

1. A method comprising:
providing, by a platform server, hotel data object information to a client device, the hotel data object information including a plurality of type attributes including a credit-type attribute;
receiving, at the platform server, a reservation request from the client device, the reservation request including an identification of the credit-type attribute;
verifying, by the platform server and in response to the reservation request, a credit authorization of a user associated with the client device;
generating, by the platform server, a credit-type booking upon verifying the credit authorization;
transmitting, by the platform server, booking information associated with the credit-type booking to a hotel data processing system associated with a hotel;
receiving, at the platform server, a check-out request from the hotel data processing system; and
transferring, by the platform server, resources associated with the booking information from a payment account associated with the user to the hotel data processing system upon receiving the check-out request.

2. The method of claim 1 wherein the credit-type booking comprises a credit stay booking.

3. The method of claim 1 wherein verifying credit authorization of a user comprises verifying a user's credit level, credit limit, number of unsettled bookings, or a combination thereof.

4. The method of claim 1 wherein the platform server and hotel data processing system communicate via a direct connection and a shared interface.

5. The method of claim 1 further comprising synchronizing, by the platform server, a booking status of the user with the hotel data processing system.

6. The method of claim 1 further comprising providing, by the platform server, one or more function options executable by the hotel data processing system or the client device.

7. The method of claim 6 wherein the function options include a function allowing the hotel data processing system to cancel a booking and wherein the method further comprises cancelling, by the platform server, the credit-type booking.

8. The method of claim 6 wherein the function options include a function allowing the hotel data processing system to verify a check-in time of the user and wherein the method further comprises:
receiving, at the platform server, an arrival time confirmation request from the hotel data processing system;
transmitting, by the platform server, a query message to the client device;
receiving, by the platform server, a response to the query from the client device, the response including a check-in time; and
transmitting, by the platform server, the response to the hotel data processing system.

9. The method of claim 6 wherein the function options include one or more of a booking type conversion, check-in, check-out, account settlement, and service operation completion notification function option.

10. The method of claim 6 wherein the function options include one or more of a business receipt issuance, current spending amount query, concierge service, room selection, unlocking, and self-check-in function option.

11. An apparatus comprising:
a processor; and
a non-transitory memory storing computer-executable instructions therein that, when executed by the processor, cause the apparatus to perform the operations of:
providing hotel data object information to a client device, the hotel data object information including a plurality of type attributes including a credit-type attribute;
receiving a reservation request from the client device, the reservation request including an identification of the credit-type attribute;
verifying, in response to the reservation request, a credit authorization of a user associated with the client device;
generating a credit-type booking upon verifying the credit authorization;
transmitting booking information associated with the credit-type booking to a hotel data processing system associated with a hotel;
receiving a check-out request from the hotel data processing system; and
transferring resources associated with the booking information from a payment account associated with the user to the hotel data processing system upon receiving the check-out request.

12. The apparatus of claim 11 wherein the credit-type booking comprises a credit stay booking.

13. The apparatus of claim 11 wherein verifying credit authorization of a user comprises verifying a user's credit level, credit limit, number of unsettled bookings, or a combination thereof.

14. The apparatus of claim 11 wherein the apparatus and hotel data processing system communicate via a direct connection and a shared interface.

15. The apparatus of claim 11 wherein the operations further comprise synchronizing a booking status of the user with the hotel data processing system.

16. The apparatus of claim 11 wherein the operations further comprise providing one or more function options executable by the hotel data processing system or the client device.

17. The apparatus of claim 16 wherein the function options include a function allowing the hotel data processing system to cancel a booking and wherein the operations further comprise cancelling the credit-type booking.

18. The apparatus of claim 16 wherein the function options include a function allowing the hotel data processing system to verify a check-in time of the user and wherein the operations further comprise:
receiving an arrival time confirmation request from the hotel data processing system;
transmitting a query message to the client device;
receiving a response to the query from the client device, the response including a check-in time; and
transmitting the response to the hotel data processing system.

19. The apparatus of claim 16 wherein the function options include one or more of a booking type conversion, check-in, check-out, account settlement, and service operation completion notification function option.

20. The apparatus of claim 16 wherein the function options include one or more of a business receipt issuance, current spending amount query, concierge service, room selection, unlocking, and self-check-in function option.
